(19) United States
(12) Patent Application Publication
(10) Pub. No.: US 2018/0113946 A1
(43) Pub. Date: Apr. 26, 2018

(54) METHOD AND DEVICE FOR DOMAIN WEB PAGE REGISTRATION

(71) Applicant: Google Inc., Mountain View, CA (US)

(72) Inventors: Gregory Sakorafis, Seattle, WA (US); Brian Duerst, Mountain View, CA (US); Lu Zeng, Seattle, WA (US); Ido Ohad, Mountain View, CA (US); Jonathan Donovan, Seattle, WA (US); Amy Camarillo, San Francisco, CA (US)

(21) Appl. No.: 15/333,565

(22) Filed: Oct. 25, 2016

(51) Int. Cl. G06F 17/30; H04L 29/08; H04L 29/12

(52) U.S. Cl. CPC G06F 17/30867; H04L 67/20; H04L 61/3025; H04L 67/02

(57) ABSTRACT

A method including: outputting, by a computing device and from a user device, web page data; receiving, by the computing device and from the user device, a domain name search query; outputting, to a domain registrar, data representative of the domain name search query; receiving, from the domain registrar in response to the domain name search query, a list of one or more available domain names; outputting, to the user device, data representative of the list of one or more available domain names; receiving, from the user device, an indication of a selection of an available domain name from the list of one or more available domain names; outputting, by the computing device, data indicative of the selection to the domain registrar; receiving, from the domain registrar, information corresponding to a purchased domain name purchased through the domain registrar; and associating the purchased domain name with the website.

### TECHNICAL FIELD

The present disclosure is related generally to domain registration, and more particularly to webpage domain registration through third-party websites.

### BACKGROUND

An online presence may be useful for many businesses and individuals. One way to achieve an online presence is through the use of a custom domain name for custom websites and e-mail addresses. For example, once a website is built using a website builder website, a custom domain name may be purchased through the website builder as a domain reseller or directly from a domain registrar. However, implementing domain reselling solutions is typically not cost effective, while, in some instances, the purchase of a domain name directly from a domain registrar may be confusing or time consuming for a user. Accordingly, there is need for a way to integrate domain registration capabilities into a third-party website

### SUMMARY

Briefly described, and according to one or more implementations, aspects of the present disclosure generally relate to methods and devices for providing domain registration capabilities through third-party websites. Certain implementations may include a method including: outputting, by a computing device, a website building interface to a user device; receiving, by the computing device and from the user device, commands for building a website; receiving, by the computing device and from the user device, a domain name search query; outputting, by the computing device and to a domain registrar, data representative of the domain name search query; receiving, from the domain registrar in response to the domain name search query, a list of one or more available domain names; outputting, to the user device, data representative of the list of one or more available domain names; receiving, from the user device, an indication of a selection of an available domain name from the list of one or more available domain names; outputting, by the computing device, data indicative of the selection to the domain registrar; receiving, from the domain registrar, information corresponding to a purchased domain name purchased through the domain registrar; associating the purchased domain name with the website.

According to certain implementations, the receiving the domain name search query, the outputting the data representative of the list, and the receiving the indication of the selection are accomplished through a widget embedded in a website builder website.

According to certain implementations, the outputting data representative of the domain name search query includes restricting the domain name search query to exclude domain names having a specified top-level domain.

According to certain implementations, the outputting the data representative of the list to the user includes: removing domain names having a specified top-level domain from the list creating an edited list; and outputting data representative of the edited list to the user device.

According to certain implementations, the outputting the data representative of the domain name search query includes restricting the domain name search query to only include domain names having a specified top-level domain.

According to certain implementations, the outputting the data representative of the list to the user includes: emphasizing domain names having a specified top-level domain from the list creating an edited list; and outputting data representative of the edited list to the user device.

Certain implementations may include a non-transitory computer readable medium having stored thereon computer program code configured to control a computing device to: receive a domain name search query; output data representative of the domain name search query to a domain registrar; receive, in response to the domain name search query, a list of one or more available domain names from the domain registrar; output data representative of the list; receive an indication of a selection of an available domain name from the list of one or more available domain names; output, to the domain registrar, data indicative of the selection; and receive, from the domain registrar, information corresponding to a purchased domain name purchased through the domain registrar.

According to certain implementations, the computer program code is configurable as a widget embeddable in a third-party website.

According to certain implementations, the computer program code is configured to control a computing device to restrict the domain name search query to exclude domain names having a specified top-level domain before outputting the data representative of the domain name search query to the domain registrar.

According to certain implementations, the computer program code is configured to control a computing device to remove domain names having a specified top-level domain from the list prior to outputting the data representative of the list.

According to certain implementations, the computer program code is configured to control a computing device to restrict the domain name search query to only include domain names having a specified top-level domain before outputting the data representative of the domain name search query to the domain registrar.

According to certain implementations, the computer program code is configured to control a computing device to emphasize domain names having a specified top-level domain from the list prior to outputting the data representative of the list.

Certain implementations may include a method including: outputting, by a computing device and to a third-party website, a domain name search query; receiving, by the computing device in response to the domain name search query, a list of one or more available domain names; outputting for display a graphic representation of the list on the third-party website; receiving, by the computing device, an indication of a user selection of an available domain name selected from the list of the one or more available domain names; outputting, by the computing device, data indicative of the user selection to the third-party website; connecting, by the computing device, to a domain registrar through the third-party website; outputting, to the domain registrar, a purchase command for the selected available domain name; and outputting for display the third-party website, information corresponding to the purchased domain name being automatically supplied to the third-party web site from the domain registrar.

According to certain implementations, the third-party website is a website building website, and the method further includes outputting, by the computing device and to the third-party website, website building commands before outputting the domain name search query.

According to certain implementations, the outputting the domain name search query, receiving the list of one or more available domain names, and the receiving the indication are accomplished through a widget embedded in the third-party website.

According to certain implementations, the domain name search query excludes domain names having a top-level domain restricted by the third-party website, and the list of one or more available domain names excludes domain names having a top-level domain restricted by the third-party website.

According to certain implementations, the list of one or more available domain names includes an emphasized domain name having a top-level domain selected to be emphasized by the third-party website.

### BRIEF DESCRIPTION OF THE DRAWINGS

The accompanying drawings illustrate one or more implementations and/or aspects of the disclosure and, together with the written description, serve to explain the principles of the disclosure. Wherever possible, the same reference numbers are used throughout the drawings to refer to the same or like elements of an implementation, and wherein:

FIG. 1 illustrates a domain registration system according to an example implementation.

FIG. 2 is a flowchart of a method according to an example implementation.

FIG. 3 is a flowchart of a method according to an example implementation.

FIG. 4 is a block diagram of an illustrative computer system architecture according to an example implementation.

### DESCRIPTION

According to some implementations of the disclosed technology, a third-party webpage may provide domain registration capabilities to a user. The third-party webpage may include code that provides interfaces for searching for available domain names and connecting to a domain registrar to execute a purchase or registration of a domain name. The code may also be configurable to limit or emphasize certain top-level domains based on a desire of the third-party. The code may also automatically configure DNS settings for newly registered domains using templates configured by the third-party. Information about a purchased domain name may be transmitted to a server associated with the third-party webpage, and the server may associate the domain name with the user.

Certain implementations of the disclosed technology provide methods and devices for providing domain registration capabilities through third-party websites. Implementations of the disclosed technology may provide domain searching, selection, and purchase options. Certain implementations may provide a third-party website with tools for limiting domain names having particular top-level domains or emphasizing domain names having particular top-level domains.

Example implementations of the disclosed technology will now be described with reference to the accompanying figures.

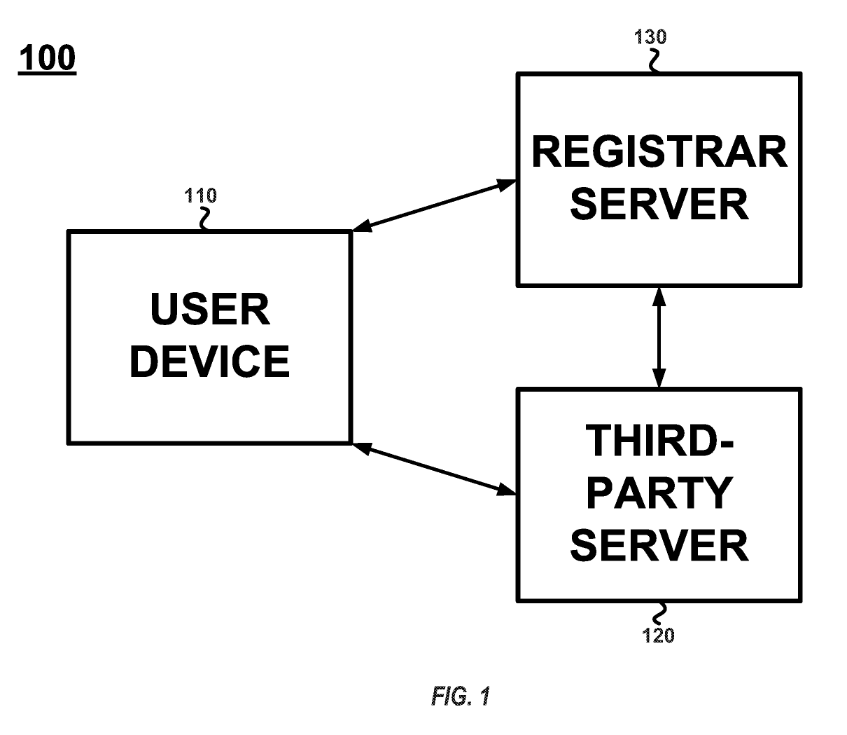

FIG. 1 illustrates a domain registration system in which one or more examples of the disclosed technology may be implemented. It will be understood that the domain registration system 100 is provided for example purposes only, and does not limit the scope of the various implementations of the present disclosed systems and methods.

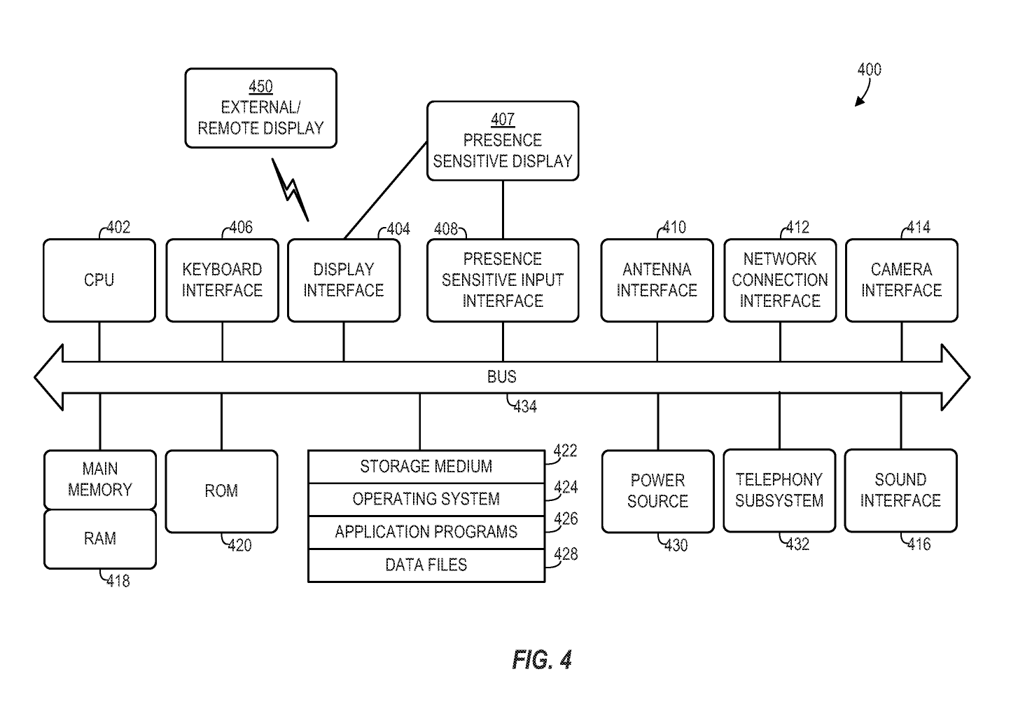

Referring to FIG. 1, the domain registration system 100 may include a user device 110, a third-party server 120, and a domain registrar server 130. According to some implementations, as non-limiting examples, the user device 110 may be a computer device and may include a personal computer (PC), a mobile computer, a laptop, a desktop, or a Smartphone. According to some implementations, the third-party server 120 and the domain registrar server 130 may be respective computer devices, and may each include one or more distinct server machines. An example of a computer architecture that may be used to implement one or more of the user device 110, the third-party server 120, and the domain registrar server 130 will be discussed below with reference to FIG. 4.

The user device 110 may communicate with the third-party server 120 to access a web page of a third-party website. Using the third-party website, the user device 110 may search for a domain name, receive a list of one or more available domain names, and select an available domain name from the list. Responsive to the selection, the user device 110 may communicate with the domain registrar server 130 to effect purchasing of a domain name from the domain registrar server 130. In some implementations, the user device 110 may communicate with the domain registrar server 130 directly. Alternatively, in some implementations, the user device 110 may communicate with the domain registrar server 130 through the third-party server 120. Once the domain name has been purchased, the user device 110 may output a display of the third-party website, and information corresponding to the purchased domain name being supplied to the third-party server 120. In some implementations, the user device 110 may transmit the information corresponding to the purchased domain name to the third-party server 120, or the domain registrar server 130 may provide the information corresponding to the purchased domain name to the third-party server 120.

The third-party server 120 may provide access to one or more web pages of one or more third-party websites. The third-party server 120 may output web page data to the user device 110. For example, in a case where the third-party website provides website building functionality, the third-party server 120 may output various interfaces for assisting a user in the creation of a customized website, and the third-party server 120 may receive commands for building a customized website from the user device 110. It will be understood that this is only an example, and the third-party server 120 may output and receive various information according to various different or additional functionalities provided by the third-party website.

According to some implementations, the third-party server 120 may receive a domain name search from the user device 110, and transmit data representative of the domain name search to the domain registrar server 130. The third-party server 120 may receive a list of available domain names from the domain registrar server 130, and transmit data representative of the list to the user device 110. The third-party server 120 may receive an indication of a selection of an available domain name search from the user device 110, and transmit data indicative of the selection to the domain registrar server 130.

According to some implementations, a widget provided within the third-party website may provide functionality for receiving a domain name search from the user device 110, transmitting data representative of the domain name search to the domain registrar server 130, receiving a list of available domain names from the domain registrar server 130, transmitting data representative of the list to the user device 110, receiving an indication of a selection of an available domain name search from the user device 110, and transmitting data indicative of the selection to the domain registrar server 130. According to some implementations, the widget may be executed on the user device 110 and may control the user device 110 to communicate with the domain registrar server 130 directly.

The third-party server 120 may receive information corresponding to a purchased domain name purchased through the domain registrar server 130, and may associate the purchased domain name with the user device 110. For example, in a case where the third-party website provides website building functionality, the third-party server 120 may point the purchased domain name to the customized website built according to commands from the user device 110.

The domain registrar server 130 may provide domain registration functionality. The domain registrar server 130 may receive a domain name search query and return a list of one or more available domain names. The domain registrar 130 may provide for the purchase of an available domain name. The domain registrar 130 may provide information corresponding to the purchased domain name to the third-party server 120.

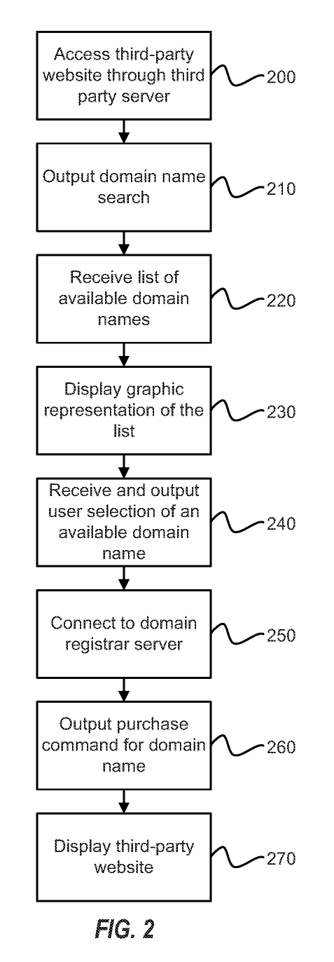

FIG. 2 is a flowchart of a method performed by a user device 110, according to an example implementation. According to FIG. 2, the user device 110 accesses 200 a third-party website on a third-party server 120. The user device 110 may receive web page data from the third-party server 120 and process the web page data to display a representation of the web page. In some implementations, the third-party website may provide website building tools, and the user device 110 may output website building commands to the third-party website.

The user device 110 outputs 210 a domain name search to the third-party website. The domain name search may be a domain name search query. The domain name search may be output using a widget embedded in the third-party website or hosted by the third-party server 120. The widget may direct the domain name search directly to a domain registrar server 130, or may route the search through the third-party server 120. According to some implementations, the domain name search may exclude domain names having a top-level domain restricted by the third-party website. According to some implementations, the domain name search may only include domain names having a top-level domain allowed by the third-party website. For example, a configuration of the widget may be configurable to restrict top-level domains searchable from the third-party website. As a non-limiting example, if the third-party website provides services for photographers, the third-party website may restrict a domain name search to include only the original top-level domain names “.com,” “.org,” and “.net,” and the generic top-level domains “.photo,” “.photography,” “.photos,” “.pics,” “.pictures.”

The user device 110 receives 220 a list of one or more available domain names in response to the domain name search. The list may only include available domain names that exactly match search criteria of the domain name search, or may include suggested alternatives that do not match all of the search criteria. According to some implementations, the list may be received by the widget. According to some implementations, the list may be received directly from the domain registrar server 130, or may be received from the third-party server 120. According to some implementations, the list may exclude domain names having a top-level domain restricted by the third-party website, or the list may only include domain names having a top-level domain allowed by the third-party website. According to some implementations, the list may include one or more available domain names having a top-level domain selected to be emphasized by the third-party website. For example, if the third-party website provides services for bloggers, the top-level domain “.blog” may be selected to be emphasized. According to some implementations, the user device 110 may remove domain names having a specified top-level domain from the list restricted by the third-party website, remove domain names not having a specified top-level domain from the list allowed by the third-party website, or emphasize domain names having a specified top-level domain selected to be emphasized by the third-party website.

The user device 110 displays 230 a graphic representation of the list. For example, the list may be displayed in the widget on the third-party website. In a case where the list includes an available domain name having a top-level domain selected to be emphasized by the third-party website, the available domain name may be emphasized, for example, by being first on the list or by having a color, font, or font-size different from other available domain names in the list. It will be understood that the described emphasis techniques are mere examples, and may be varied according to various example implementations.

The user device 110 receives 240 an indication of a user selection of an available domain name selected from the list of the one or more available domain names, and outputs data indicative of the user selection to the third-party website. For example, the user device 110 may output the data indicative of the user selection to the widget. According to some implementations, the widget may direct the data indicative of the user selection directly to a domain registrar server 130, or may route the search through the third-party server 120.

The user device 110 connects 250 to the domain registrar server 130 through the third-party website. For example, in response to the user selection, the widget may connect the user device 110 to the domain registrar server 130. In some implementations, the user device 110 may provide an indication of a configuration of DNS settings to the domain registrar server 130. For example, the widget may transmit a template with DNS settings to the domain registrar 130. In some implementations, the DNS template may be configured by the third-party for use with a web service provided by the third party.

The user device 110 outputs 260 a purchase command for the selected domain name to the domain registrar server 130. For example, the user device 110 may provide identification information and payment information to the domain registrar server 130 in order to secure a purchase of the selected domain name. It will be understood that the user device 110 may output a purchase command for one or more other domain names in addition to or instead of the selected domain name.

Once the purchase is complete, the user device 110 may display 270 a representation of the third-party website. Information corresponding to the purchased domain name is automatically supplied to the third-party server 120. For example, the domain registrar server 130 may provide the information corresponding to the purchased domain to the third-party sever 120, or the user device 110 may provide the information corresponding to the purchased domain to the third-party server 120 under instructions from the widget. The information corresponding to the purchased domain may include DNS settings information.

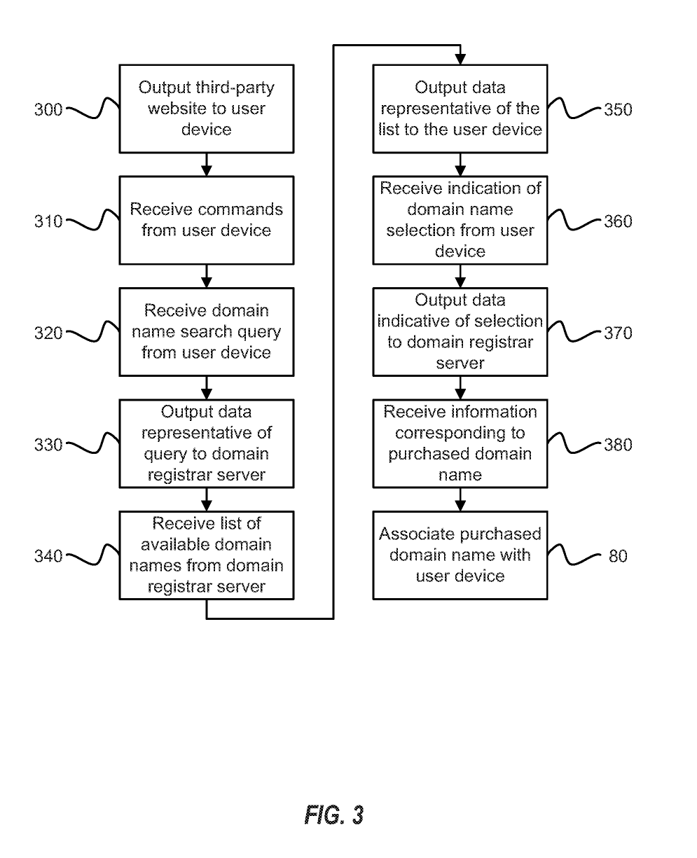

FIG. 3 is a flowchart of a method performed by a computer device, such as the third-party server 120, according to an example implementation. According to FIG. 3, the third-party server 120 outputs 300 third-party website data to the user device 110. As a non-limiting example, the third-party server 120 may output a website building interface to the user device 110.

The third-party server 120 receives 310 various user commands from the user device 110 according to the third-party website. For example, the third-party server 120 may receive commands for building a website from the user device 110.

The third-party server 120 receives 320 a domain name search query from the user device 110. For example, the third-party website may include a widget, and the widget may provide an interface for receiving a domain name search query, and may control forwarding of the search query to the third-party server 120. According to some implementations, the widget may be provided by the third-party server 120 as part of the third-party website.

The third-party server 120 outputs 330 data representative of the domain name search query to the domain registrar server 130. According to some implementations, the third-party server 130 may restrict the domain name search query to exclude domain names having a specified top-level domain. According to some implementations, the third-party server 130 may restrict the domain name search query to only include domain names having a specified top-level domain.

The third-party server 120 receives 340, in response to the domain name search query, a list of available domain names from the domain registrar server 130.

The third-party server 120 outputs 350 data representative of the list to the user device 110. For example, the third-party server 120 may output the data representative of the list for display by the widget. In some implementations, the third-party server 120 may create an edited list by removing domain names having a specified top-level domain from the list, and may instead output data representative of the edited list to the user device 110. In some implementations, the third-party server 120 may create the edited list by removing domain names not having a specified top-level domain from the list. According to some implementations, the third-party server 120 may create the edited list by emphasizing domain names having a specified top-level domain from the list creating an edited list.

The third-party server 120 receives 360 an indication of a selection of an available domain name from the list of one or more available domain names from the user device 110. The widget may receive the user selection from the user device 110 and control forwarding of the indication of the selection to the third-party server 120.

The third-party server 120 outputs 370 data indicative of the selection to the domain registrar server 130. The user device 110 may then connect to the domain registrar server 130 to effect a purchase of a domain name. In some implementations, the user device 110 may provide an indication of a configuration of DNS settings to the domain registrar server 130. For example, the widget may transmit a template with DNS settings to the domain registrar 130 to automatically configure DNS settings. In some implementations, the DNS template may be previously configured by the third-party for use with a web service provided by the third party. The template may include resource records to be automatically added to new domains (e.g., A, AAAA, CNAME, and MX), domain and sub-domains on which the widget should be used, and fields to be passed to the domain registrar server 130.

The third-party server 120 receives 380, in response to a domain being purchased by the user device 110 from the domain registrar server 130, information corresponding to the purchased domain name. According to some implementations, the third-party server 120 receives the information directly from the domain registrar server 130. In some implementations, the third-party server 120 receives the information from the user device 110, for example, under control of the widget. In some implementations, the information corresponding to the purchased domain may include DNS settings information. The DNS settings information may be set according to the template provided by the widget.

The third-party server 120 associates 390 the purchased domain name with the user device 110. For example, the third-party server 120 may associate the purchased domain name with a website built by the user terminal 110 using the third-party website.

According to some implementations, the third-party website may contain instructions for communicating directly with the domain registrar server 130, for example, in the widget. In some implementations, the third-party server 120 may not receive or transmit the domain name search query, the list of available domain names, or the indication of a selection of an available domain names. Rather, the user device 110 may communicate directly with the domain registrar server 130 to accomplish similar functionality, for example, under control of the widget.

According to one or more implementations, computer program code may be stored on a non-transitory computer readable medium that, when executed by a computing device, control the computing device to perform one or more methods. The computer program code may be configurable as a widget embedded in or embeddable into a website.

The computer program code may include instructions that, when executed by a computing device control the computing device to: receive a domain name search query, output data representative of the domain name search query to a domain registrar server 130, receive a list of one or more available domain names from the domain registrar server 130, output data representative of the list, receive an indication of a selection of an available domain name from the list, output data indicative of the selection to the domain registrar 130, and receive, from the domain registrar 130, information corresponding to a purchased domain name purchased through the domain registrar 130.

According to some implementations, the computer program code may control the computing device to restrict the domain name search query to exclude domain names having a specified top-level domain before outputting the data representative of the domain name search query to the domain registrar.

According to some implementations, the computer program code may control the computing device to remove, from the list, domain names having a specified top-level domain from the list prior to outputting the data representative of the list.

According to some implementations, the computer program code may control the computing device to restrict the domain name search query to only include domain names having a specified top-level domain before outputting the data representative of the domain name search query to the domain registrar.

According to some implementations, the computer program code may control the computing device to remove, from the list, domain names not having a specified top-level domain from the list prior to outputting the data representative of the list.

According to some implementations, the computer program code may control the computing device to emphasize, in the list, domain names having a specified top-level domain from the list prior to outputting the data representative of the list.

FIG. 4 is a block diagram of an illustrative computer system architecture 400, according to an example implementation. For example, the user device 110, the third-party server 120, and the domain registrar server 130 may be implemented using one or more elements from the computer system architecture 400. It will be understood that the computing device architecture 400 is provided for example purposes only and does not limit the scope of the various implementations of the present disclosed systems, methods, and computer-readable mediums.

The computing device architecture 400 of FIG. 4 includes a central processing unit (CPU) 402, where computer instructions are processed, and a display interface 404 that acts as a communication interface and provides functions for rendering video, graphics, images, and texts on the display. In certain example implementations of the disclosed technology, the display interface 404 may be directly connected to a local display, such as a touch-screen display associated with a mobile computing device. In another example implementation, the display interface 404 may be configured for providing data, images, and other information for an external/remote display 450 that is not necessarily physically connected to the mobile computing device. For example, a desktop monitor may be used for mirroring graphics and other information that is presented on a mobile computing device. In certain example implementations, the display interface 404 may wirelessly communicate, for example, via a Wi-Fi channel or other available network connection interface 412 to the external/remote display 450.

In an example implementation, the network connection interface 412 may be configured as a communication interface and may provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof. In one example, the display interface 404 may be operatively coupled to a local display, such as a touch-screen display associated with a mobile device. In another example, the display interface 404 may be configured to provide video, graphics, images, text, other information, or any combination thereof for an external/remote display 450 that is not necessarily connected to the mobile computing device. In one example, a desktop monitor may be used for mirroring or extending graphical information that may be presented on a mobile device. In another example, the display interface 404 may wirelessly communicate, for example, via the network connection interface 412 such as a Wi-Fi transceiver to the external/remote display 450.

The computing device architecture 400 may include a keyboard interface 406 that provides a communication interface to a keyboard. In one example implementation, the computing device architecture 400 may include a presence-sensitive display interface 408 for connecting to a presence-sensitive display 407. According to certain example implementations of the disclosed technology, the presence-sensitive display interface 408 may provide a communication interface to various devices such as a pointing device, a touch screen, a depth camera, etc. which may or may not be associated with a display.

The computing device architecture 400 may be configured to use an input device via one or more of input/output interfaces (for example, the keyboard interface 406, the display interface 404, the presence sensitive display interface 408, network connection interface 412, camera interface 414, sound interface 416, etc.,) to allow a user to capture information into the computing device architecture 400. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device architecture 400 or may be a separate device. For example, the input device may be an accelerometer, a magnetometer, a digital camera, a microphone, and an optical sensor.

Example implementations of the computing device architecture 400 may include an antenna interface 410 that provides a communication interface to an antenna; a network connection interface 412 that provides a communication interface to a network. As mentioned above, the display interface 404 may be in communication with the network connection interface 412, for example, to provide information for display on a remote display that is not directly connected or attached to the system. In certain implementations, a camera interface 414 is provided that acts as a communication interface and provides functions for capturing digital images from a camera. In certain implementations, a sound interface 416 is provided as a communication interface for converting sound into electrical signals using a microphone and for converting electrical signals into sound using a speaker. According to example implementations, a random access memory (RAM) 418 is provided, where computer instructions and data may be stored in a volatile memory device for processing by the CPU 402.

According to an example implementation, the computing device architecture 400 includes a read-only memory (ROM) 420 where invariant low-level system code or data for basic system functions such as basic input and output (I/O), startup, or reception of keystrokes from a keyboard are stored in a non-volatile memory device. According to an example implementation, the computing device architecture 400 includes a storage medium 422 or other suitable type of memory (e.g. such as RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 424, application programs 426 (including, for example, a web browser application, a widget or gadget engine, and or other applications, as necessary) and data files 428 are stored. According to an example implementation, the computing device architecture 400 includes a power source 430 that provides an appropriate alternating current (AC) or direct current (DC) to power components.

According to an example implementation, the computing device architecture 400 includes a telephony subsystem 432 that allows the device 400 to transmit and receive sound over a telephone network. The constituent devices and the CPU 402 communicate with each other over a bus 434.

According to an example implementation, the CPU 402 has appropriate structure to be a computer processor. In one arrangement, the CPU 402 may include more than one processing unit. The RAM 418 interfaces with the computer bus 434 to provide quick RAM storage to the CPU 402 during the execution of software programs such as the operating system application programs, and device drivers. More specifically, the CPU 402 loads computer-executable process steps from the storage medium 422 or other media into a field of the RAM 418 in order to execute software programs. Data may be stored in the RAM 418, where the data may be accessed by the computer CPU 402 during execution.

The storage medium 422 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium 422, which may include a machine-readable storage medium.

According to one example implementation, the term computing device, as used herein, may be a CPU, or conceptualized as a CPU (for example, the CPU 402 of FIG. 4). In this example implementation, the computing device (CPU) may be coupled, connected, and/or in communication with one or more peripheral devices, such as display. In another example implementation, the term computing device, as used herein, may refer to a mobile computing device such as a Smartphone, tablet computer, or smart watch. In this example implementation, the computing device may output content to its local display and/or speaker(s). In another example implementation, the computing device may output content to an external display device (e.g., over Wi-Fi) such as a TV or an external computing system.

In example implementations of the disclosed technology, a computing device may include any number of hardware and/or software applications that are executed to facilitate any of the operations. In example implementations, one or more I/O interfaces may facilitate communication between the computing device and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device. The one or more I/O interfaces may be used to receive or collect data and/or user instructions from a wide variety of input devices. Received data may be processed by one or more computer processors as desired in various implementations of the disclosed technology and/or stored in one or more memory devices.

One or more network interfaces may facilitate connection of the computing device inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems.

According to some implementations, the computer program code may control the computing device to provide an indication of a configuration of DNS settings to the domain registrar server 130. The computer program code may refer to a DNS template for DNS settings. In some implementations, the DNS template may be previously configurable by the third-party. The template may include resource records to be automatically added to new domains (e.g., A, AAAA, CNAME, and MX), domain and sub-domains on which the widget should be used, and other fields to be passed to the domain registrar server 130.

According to an implementation, a computing device outputs web page data to a user device, receives and processes commands from the user device, receives a domain name search query from the user device and outputs the domain name search query to a domain registrar, receiving available domain names from the domain registrar and outputs the available domain names to the user device, receives an indication of a selected domain name and outputs the indication to the domain registrar, receives information corresponding to a purchased domain name, and associates the purchased domain name with the user device. The computing device may provide DNS settings to the domain registrar. The DNS settings may be determined by a template. The computing device may restrict the domain name search query or the output available domain names to certain top-level domains. The computing device may emphasize domain names having particular top-level domains.

According to an implementation, a computing device outputs web page data to a user device, receives and processes commands from the user device, and associates a purchased domain name with the user device. The web page data includes computer program code for: receiving a domain name search query, outputting data representative of the domain name search query to a domain registrar, receiving, in response to the domain name search query, available domain names from the domain registrar, outputting a list of the available domain names, receiving a selection of an available domain name, and connecting to the domain registrar to effectuate a purchase of an available domain. The computer program code may provide DNS settings to the domain registrar. The DNS settings may be determined by a template. The computer program code may be a widget embedded in the web page or hosted by the computing device. The computer program code may restrict the domain name search query or the output available domain names to certain top-level domains. The computer program code may emphasize domain names having particular top-level domains.

According to an implementation, a computing device outputs a domain name search query to a third-party website, receives available domain names and outputs for display a list of the available domain names, receives an indication of a selected domain name and outputs the indication, connects to a domain registrar through the third-party website, outputs a purchase command for a domain name, and outputs a graphic representation of the third-party website with information corresponding to the purchased domain name being automatically supplied to the third-party website. The third-party website may provide a website building interface and the computing device may output website building commands to the third-party website. The domain name search query or the available domain names may be restricted to certain top-level domains by settings in the third-party website. The domain names having particular top-level domains may be emphasized according to setting in the third-party website.

While certain implementations of the disclosed technology have been described in connection with what is presently considered to be the most practical and various implementations, it is to be understood that the disclosed technology is not to be limited to the disclosed implementations, but on the contrary, is intended to cover various modifications and equivalent arrangements included within the scope of the appended claims and their equivalents. Although specific terms are employed herein, they are used in a generic and descriptive sense only and not for purposes of limitation.

In the foregoing description, numerous specific details are set forth. It is to be understood, however, that implementations of the disclosed technology may be practiced without these specific details. In other instances, well-known methods, structures and techniques have not been shown in detail in order not to obscure an understanding of this description. References to “one implementation,” “an implementation,” “example implementation,” “various implementation,” etc., indicate that the implementation(s) of the disclosed technology so described may include a particular feature, structure, or characteristic, but not every implementation necessarily includes the particular feature, structure, or characteristic. Further, repeated use of the phrase “in one implementation” does not necessarily refer to the same implementation, although it may.

Throughout the specification and the claims, the following terms should be construed to take at least the meanings explicitly associated herein, unless the context clearly dictates otherwise. The term “connected” means that one function, feature, structure, or characteristic is directly joined to or in communication with another function, feature, structure, or characteristic. The term “coupled” means that one function, feature, structure, or characteristic is directly or indirectly joined to or in communication with another function, feature, structure, or characteristic. The term “or” is intended to mean an inclusive “or.” Further, the terms “a,” “an,” and “the” are intended to mean one or more unless specified otherwise or clear from the context to be directed to a singular form.

As used herein, unless otherwise specified the use of the ordinal adjectives “first,” “second,” “third,” etc., to describe a common object, merely indicate that different instances of like objects are being referred to, and are not intended to imply that the objects so described must be in a -given sequence, either temporally, spatially, in ranking, or in any other manner.

This written description uses examples to disclose certain implementations of the disclosed technology, including the best mode, and also to enable any person of ordinary skill to practice certain implementations of the disclosed technology, including making and using any devices or systems and performing any incorporated methods. The patentable scope of certain implementations of the disclosed technology is defined in the claims and their equivalents, and may include other examples that occur to those of ordinary skill. Such other examples are intended to be within the scope of the claims if they have structural elements that do not differ from the literal language of the claims, or if they include equivalent structural elements with insubstantial differences from the literal language of the claims.

What is claimed is:

1. A method comprising:
outputting, by a computing device, a website building interface to a user device;
receiving, by the computing device and from the user device, commands for building a website;
receiving, by the computing device and from the user device, a domain name search query;
outputting, by the computing device and to a domain registrar, data representative of the domain name search query;
receiving, from the domain registrar in response to the domain name search query, a list of one or more available domain names;
outputting, to the user device, data representative of the list of one or more available domain names;
receiving, from the user device, an indication of a selection of an available domain name from the list of one or more available domain names;
outputting, by the computing device, data indicative of the selection to the domain registrar;
receiving, from the domain registrar, information corresponding to a purchased domain name purchased through the domain registrar; and
associating the purchased domain name with the website.

2. The method of claim 1, wherein the receiving the domain name search query, the outputting the data representative of the list, and the receiving the indication of the selection are accomplished through a widget embedded in a website builder website.

3. The method of claim 1, wherein the outputting data representative of the domain name search query comprises restricting the domain name search query to exclude domain names having a specified top-level domain.

4. The method of claim 1, wherein the outputting the data representative of the list to the user comprises:
removing domain names having a specified top-level domain from the list creating an edited list; and
outputting data representative of the edited list to the user device.

5. The method of claim 1, wherein the outputting the data representative of the domain name search query comprises restricting the domain name search query to only include domain names having a specified top-level domain.

6. The method of claim 1, wherein the outputting the data representative of the list to the user comprises:
emphasizing domain names having a specified top-level domain from the list creating an edited list; and
outputting data representative of the edited list to the user device.

7. A non-transitory computer readable medium having stored thereon computer program code configured to control a computing device to:
receive a domain name search query;
output data representative of the domain name search query to a domain registrar;
receive, in response to the domain name search query, a list of one or more available domain names from the domain registrar;
output data representative of the list;
receive an indication of a selection of an available domain name from the list of one or more available domain names;
output, to the domain registrar, data indicative of the selection; and
receive, from the domain registrar, information corresponding to a purchased domain name purchased through the domain registrar.

8. The non-transitory computer readable medium of claim 7, wherein the computer program code is configurable as a widget embeddable in a third-party website.

9. The non-transitory computer readable medium of claim 7, wherein the computer program code is configured to control a computing device to restrict the domain name search query to exclude domain names having a specified top-level domain before outputting the data representative of the domain name search query to the domain registrar.

10. The non-transitory computer readable medium of claim 7, wherein the computer program code is configured to control a computing device to remove domain names having a specified top-level domain from the list prior to outputting the data representative of the list.

11. The non-transitory computer readable medium of claim 7, wherein the computer program code is configured to control a computing device to restrict the domain name search query to only include domain names having a specified top-level domain before outputting the data representative of the domain name search query to the domain registrar.

12. The non-transitory computer readable medium of claim 7, wherein the computer program code is configured to control a computing device to emphasize domain names having a specified top-level domain from the list prior to outputting the data representative of the list.

13. A method comprising:
outputting, by a computing device and to a third-party website, a domain name search query;
receiving, by the computing device in response to the domain name search query, a list of one or more available domain names;
outputting for display a graphic representation of the list on the third-party website;
receiving, by the computing device, an indication of a user selection of an available domain name selected from the list of the one or more available domain names;
outputting, by the computing device, data indicative of the user selection to the third-party website;
connecting, by the computing device, to a domain registrar through the third-party website;
outputting, to the domain registrar, a purchase command for the selected available domain name; and
outputting for display the third-party website, information corresponding to the purchased domain name being automatically supplied to the third-party website from the domain registrar.

14. The method of claim 13, wherein
the third-party website is a website building website, and
the method further comprises outputting, by the computing device and to the third-party website, website building commands before outputting the domain name search query.

15. The method of claim 13, wherein the outputting the domain name search query, receiving the list of one or more available domain names, and the receiving the indication are accomplished through a widget embedded in the third-party website.

16. The method of claim 13, wherein
the domain name search query excludes domain names having a top-level domain restricted by the third-party website, and
the list of one or more available domain names excludes domain names having a top-level domain restricted by the third-party website.

17. The method of claim 13, wherein the list of one or more available domain names comprises an emphasized domain name having a top-level domain selected to be emphasized by the third-party website.
